(19) United States
(12) Patent Application Publication
(10) Pub. No.: US 2025/0372758 A1
(43) Pub. Date: Dec. 4, 2025

(54) Method for Producing an Electrical Accumulator, and Apparatus for Producing an Electrical Accumulator

(71) Applicant: Bayerische Motoren Werke Aktiengesellschaft, Muenchen (DE)

(72) Inventor: Simon WUERZINGER, Wildenberg (DE)

(21) Appl. No.: 18/874,179

(22) PCT Filed: Aug. 9, 2023
(86) PCT No.: PCT/EP2023/072006

§ 371 Date: Dec. 12, 2024

(30) Foreign Application Priority Data
Sep. 7, 2022 (DE) 10 2022 122 655.7

(51) Int. Cl. H01M 10/6555; H01M 10/04; H01M 10/613; H01M 10/643

(52) U.S. Cl. CPC H01M 10/6555; H01M 10/0404; H01M 10/613; H01M 10/643

(57) ABSTRACT

A method for producing an electrical accumulator includes the steps of: providing a cooling element which extends along a longitudinal axis and has a first side face and a second side face; applying adhesive onto the first side face; arranging at least one energy-storage cell on the first side face while, particularly interlockingly, supporting the cooling element from the second side face.

### BACKGROUND AND SUMMARY

The invention relates to a method for producing an electrical accumulator, and to an apparatus for producing an electrical accumulator.

Electrical accumulators such as used in partially or fully electrically operated motor vehicles comprise a large number of accumulator cells which are in mutual electrical contact and wired to one another. Cooling elements are typically provided for cooling.

DE 10 2008 027 293 A1, for example, discloses an apparatus for cooling a vehicle battery, comprising a plurality of electrical storage elements and a cooling body with ducts for a fluid to flow therethrough, wherein the electrical storage elements are in thermal contact with the cooling body and heat from the storage elements is able to be transmitted to the fluid. The large number of installed accumulator cells, the electrical contacting and cooling of which, and the ensuring of further requirements such as, for example, safety requirements, or meeting of structural/mechanical parameters, make the production of electrical accumulator cells a very complex undertaking.

It is therefore an object of the present invention to provide a method for producing an electrical accumulator and an apparatus for producing an electrical accumulator, wherein, in particular, rapid manufacturing in a reliable process is to be made possible while meeting the most stringent quality requirements.

This object is achieved by a method and by an apparatus in accordance with the independent claim(s). Further advantages and features are derived from the dependent claims and the description and the appended figures.

According to the invention, a method for producing an electrical accumulator comprises the following steps:
providing a cooling element which extends along a longitudinal axis and has a first lateral face and a second lateral face;
applying adhesive to the first lateral face;
arranging at least one accumulator cell on the first lateral face and in the process supporting, in particular in a form-fitting manner, the cooling element from the direction of the second lateral face.

According to a preferred embodiment, the accumulator cell is a cylindrical accumulator cell, in particular a round cell. According to one embodiment, the cooling element is made of a metallic material such as, for example, a light metal such as aluminum. According to one embodiment, the cooling element is an extruded profile. According to one embodiment, the cooling element has a multiplicity of ducts which preferably extend along the longitudinal axis. These ducts can be designed in such a way that a (cooling) fluid can be transported in one direction, for example in an upper region of the cooling element in terms of a vertical axis of the cooling element, oriented perpendicularly to the longitudinal axis, and transported in the opposite direction in the lower region. According to one embodiment, the height when viewed along the vertical axis has a height, for example, of 6 to 10 cm, while a thickness is preferably in the range of a few millimeters, for example 3 to 8 mm. The length may vary significantly, depending on the embodiment and size of the accumulator to be constructed. For example, the length can be 50 cm, 75 cm, 100 cm, 125 cm or even more.

According to one preferred embodiment, the accumulator cell or cells is/are round cells.

When arranging the at least one accumulator cell, the cooling element is expediently supported, preferably in a form-fitting manner, preferably in particular in the region that lies opposite the arrangement or contact region of the respective accumulator cell that is currently being arranged. The support at least in regions makes it possible for the adhesive gap to be set in a defined manner. Depending on how the support is implemented, the cooling element can therefore expediently also be plastically deformed.

According to one preferred embodiment, the method comprises the following step:
using a counterholder for support, which over the entire area or in portions is adapted to a target shape of the cooling element.

According to one preferred embodiment, the cooling element has a wave shape along the longitudinal axis, wherein the accumulator cells are in each case positioned or to be positioned in the respective wave troughs.

According to one embodiment, the counterholder has a multiplicity of compression pieces which are conceived for supporting the cooling element in regions or portions. For example, the compression pieces are mutually spaced apart along the longitudinal axis in such a manner that the accumulator cells to be arranged in the respective wave troughs can be supported. In other words, the wave trough formed on the first lateral face can be supported opposite on the second lateral face by a compression piece which is correspondingly shaped in a congruent manner. Alternatively, the counterholder has a shape or geometry which is conceived for supporting the cooling element over the entire area, or approximately over the entire area, along the longitudinal axis. The counterholder expediently acts like a mold, or a molding tool, into which the cooling element can be pressed by way of the arrangement of one or a plurality of accumulator cells. In this way, it is expediently possible to level out, or compensate for, potential manufacturing tolerances or the like.

Moreover, the support in regions by means of counterholders also enables the precise setting of, in particular also thin, adhesive gaps. On the one hand, it is thus advantageously possible to save adhesive. On the other hand, the required installation space is reduced, or it is consequently possible to work with larger tolerances at another location, respectively.

Accordingly, the method advantageously comprises the following step:
recalibrating or aligning the cooling element when arranging the at least one accumulator cell, or by way of the arrangement of the latter.

The method expediently comprises the following step:
forming the cooling element at least in regions when arranging the at least one accumulator cell in such a manner that an adhesive gap is formed, which when viewed along a vertical axis is designed in the shape of a crescent, or substantially in the shape of a crescent.

A crescent-shaped adhesive gap of this type advantageously enables the uniform distribution of the adhesive. Owing to the fact that the counterholder is used for support, it can moreover be ensured that the adhesive gap is identical for all accumulator cells. In this way, a consistent and above all also uniform manufacturing quality is advantageously enabled. The adhesive is not distributed in any random manner, but is distributed in a defined manner by way of the adhesive gap formed in a targeted and defined manner.

It is to be pointed out here that, according to a preferred embodiment, the adhesive is arranged in two tracks that extend along the longitudinal axis so as to be mutually spaced apart and disposed on top of one another along the vertical axis. The adhesive is first applied to the first lateral face. The arrangement of the at least one accumulator cell is performed subsequently.

According to one embodiment, the method comprises the following step:

holding the at least one accumulator cell during arrangement in such a manner that an alignment relative to the cooling element is possible.

During arrangement or handling, the accumulator cell is expediently held in such a manner that it can align itself relative to the counterholder. In other words: by using the counterholder, not only is the cooling element supported and brought to a target shape when interacting with the arrangement of the accumulator cell. Exact positioning of the at least one accumulator cell expediently also takes place by way of the counterholder.

According to one embodiment, the method comprises the following steps:
arranging a multiplicity of accumulator cells on a first lateral face sequentially or simultaneously, so as to generate a first cell row;
applying adhesive to the second, opposite lateral face of the cooling element.

The application of the adhesive to the second lateral face expediently takes place in the same arrangement or configuration as to the first lateral face.

According to one embodiment, the method comprises the following step:
arranging a multiplicity of accumulator cells on the second lateral face sequentially or simultaneously, so as to generate a second cell row.

The method is extremely flexible and enables the construction of single-row or double-row segments. When generating the second cell row, the cooling element is expediently already ideally shaped indirectly by way of the arrangement of the cells on the first lateral face.

According to one embodiment, the method comprises the following steps:
arranging a multiplicity of segments next to one another, each comprising one cooling element and one or two cell rows, so as to generate or construct an accumulator.

The arrangement comprising a cooling element on which one or two cell rows are arranged is presently referred to as a segment. It is advantageously possible to construct the accumulator from segments which have one and/or two cell rows. According to one embodiment, separate cooling elements can also be arranged between the segments. This can be advantageous in particular when double-row segments are installed.

The arrangement of a (new) segment preferably takes place prior to the expiry of the chemical cure time of the adhesive used of the respective segment. In this way, at the least a minimal, subsequent alignment of the accumulator cells is possible or guaranteed. Within the cure time, the adhesive maintains its original wetting capability so that the components to be adhesively bonded can be joined and adjusted. Typical cure times of preferred adhesives are in the range of seconds or (a few) minutes, for example.

According to one embodiment, the method comprises the following step:
connecting the cooling elements.

As has already been mentioned, the cooling elements extend in each case along a, or the, longitudinal axis. The same applies in a corresponding manner to the cell rows formed on the cooling elements. The electrical accumulator, or the accumulator cells, are presently expediently arranged in such a way that a multiplicity of cell rows are arranged row-by-row along a transverse direction, thus perpendicularly to the longitudinal axis. The cooling elements are expediently designed in such a manner that they have corresponding connectors or connecting elements on one side so that a continuous cooling path can be implemented.

The method expediently comprises the following step:
applying a compressive force by way of the accumulator cells when positioning the cooling element on the other cell row.

Expediently, the respective cooling element is always pressed onto the cell row already present by way of the accumulator cells.

According to one embodiment, after the arrangement of the accumulator cells, or of the cell rows, the electrical contacting or wiring of the latter takes place. Thereafter, the arrangement in a corresponding housing expediently takes place, which housing is subsequently installed in a motor vehicle such as, for example, a passenger motor vehicle, a commercial vehicle or else a motorcycle.

The arrangement of the cell rows next to one another can be performed on an auxiliary element, for example on a special table or the like. Alternatively, the arrangement can also be performed directly on a component which later remains in the completed accumulator. This may optionally facilitate the handling of the entire arrangement.

The invention is also directed toward an apparatus for producing an electrical accumulator, comprising at least one counterholder and a handling device, wherein the counterholder is configured for arranging and supporting at least in regions a cooling element which extends along a longitudinal axis, and wherein the handling device is configured for arranging at least one accumulator cell on a cooling element which is disposed on the counterholder.

According to one embodiment, the aforementioned handling device can be formed by a robot which is configured to handle one or a plurality of accumulator cells. Alternatively, the handling device can also be designed as a specially designed apparatus which is constructed especially for this purpose. A handling device of this type comprises, for example, a receptacle for arranging or fastening a corresponding counterholder. According to one embodiment, the counterholder is designed to be displaceable at least along a vertical axis. The vertical axis mentioned here refers to the vertical axis of the accumulator cells, for example. In this way it is possible, for example, to expose the second lateral face upon arrangement of the accumulator cells on the first lateral face, so as to apply adhesive thereto.

According to one embodiment, the counterholder has a multiplicity of compression pieces which are conceived to support a cooling element in regions or portions. According to one embodiment, the compression pieces are in each case designed to be movable or displaceable, in particular along the aforementioned vertical axis, for example, or else along the longitudinal axis, or in the plane defined by the vertical axis and the longitudinal axis.

According to one embodiment, the counterholder is configured for supporting a cooling element over the entire area. In this embodiment in particular, the counterholder can act in a manner similar to a molding tool which can expediently be used for reshaping or recalibrating, or aligning/erecting, a cooling element arranged therein.

A contact face of the counterholder that is provided to support the cooling element in regions expediently has a radius which is conceived to generate a crescent-shaped adhesive gap. For example, the radius on the contact face is expediently smaller than the radius of the preferably cylindrical accumulator cell. As has already been mentioned, a positive distribution of adhesive can on the one hand be achieved by way of the crescent-shaped design embodiment of the adhesive gap. Moreover, thin adhesive gaps can be implemented, which moreover are able to be implemented in a precisely reproducible manner in a reliable process. The adhesive is thus not distributed randomly or irregularly, but in a highly targeted manner. Precise and resource-efficient work is thus advantageously made possible.

Further advantages and features are derived from the description hereunder of embodiments of the method, or of an apparatus, with reference to the appended figures.

### BRIEF DESCRIPTION OF THE DRAWINGS

FIG. 1 shows two views for visualizing a fundamental principle of the method;

FIG. 2 is a schematic view of an embodiment of a handling device;

FIG. 3 shows the handling device known from FIG. 2 in another position;

FIG. 4 is a schematic detailed view in which a crescent-shaped adhesive gap can be seen; and

FIG. 5 is a schematic diagram which shows the arrangement of a plurality of segments next to one another.

### DETAILED DESCRIPTION OF THE DRAWINGS

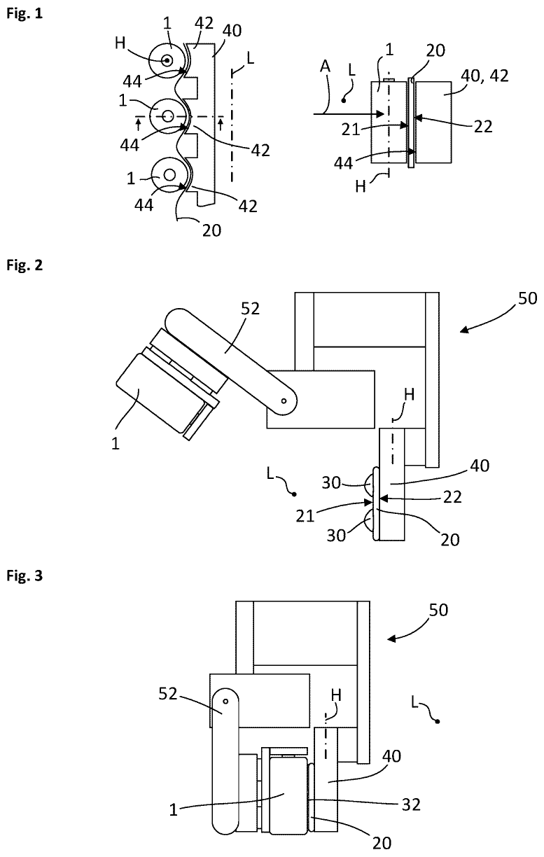

FIG. 1 shows a cooling element 20 which has a wave shape and extends along a longitudinal axis L. The cooling element 20 has a first lateral face 21 as well as a second lateral face 22, wherein a plurality of accumulator cells 1 are arranged in the wave troughs of the first lateral face 21. These accumulator cells 1 extend in each case along a vertical axis H. To be seen is a counterholder 40 which is configured to support the cooling element 20 in regions or portions, in particular in the region in which the arrangement of the accumulator cells 1 takes place. In the present embodiment of the counterholder 40, the latter has corresponding compression pieces 42 which have contact faces 44. Illustrated in the right half of the image is a section such as is schematically shown in the left half of the image. It can be seen here that the cooling element 20, when arranging the accumulator cells, can be supported along the arrangement direction A when the accumulator cells are being arranged, this taking place by way of the arrangement of the counterholder, or of the compression piece 42. The vertical axis H as well as the longitudinal axis L form a plane perpendicular to which, i.e. along the arrangement direction A, the arrangement of the accumulator cells 1 takes place. It can be seen that when using a counterholder 40 of this type, cf. in particular the left half of the image, a correspondingly designed cooling element 20, which presently has a wave shape, can still be subsequently calibrated, aligned or oriented by way of the arrangement of the accumulator cells 1. In particular, potential dimensional tolerances which the cooling element 20 may have, can be levelled out by way of the arrangement of the accumulator cells 1. The counterholder 40 acts like a molding tool which can act in interaction with the force applied by the accumulator cells 1 to the cooling element 20.

FIG. 2 shows in a schematic view an embodiment of a handling device 50 which comprises a pivot arm 52 on which is arranged an accumulator cell 1. The handling device 50 comprises a counterholder 40 on which a cooling element 20 is already arranged. The latter has a first lateral face 21 as well as a second lateral face 22, and extends along a vertical axis H, or into the drawing plane, respectively, along a longitudinal axis L. Presently, two adhesive tracks 30 have already been applied along the latter.

FIG. 3 now shows the handling device 50, known from FIG. 2, wherein the pivot arm 52 has been displaced in such a manner that the accumulator cell 1, or a plurality of the latter, is/are arranged on the first lateral face 21 of the cooling element 20. It is not illustrated here that the counterholder 40 can be displaced along the vertical axis H, presently in particular upward, for example. In this way, the second lateral face 22 can be exposed. Consequently, an application of adhesive can also take place here.

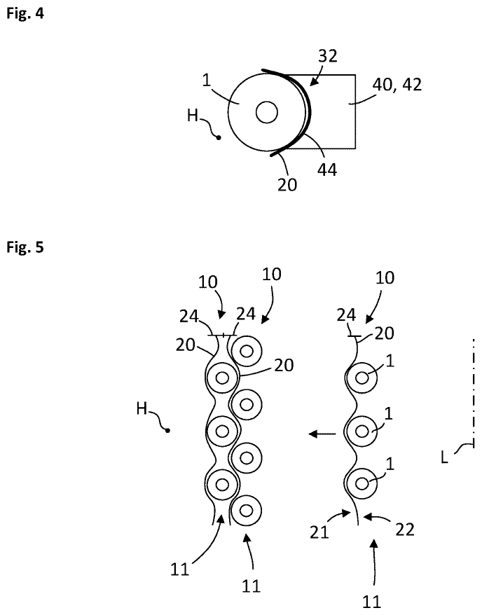

FIG. 4 shows a detailed view, wherein a cylindrical accumulator cell 1 which extends along a vertical axis H can be seen. A cooling element 20, which is presently illustrated only in portions, is supported by way of a counterholder 40, or a compression piece 42. The latter comprises a contact face 44 which is presently shaped in such a manner that, when interacting with the arrangement of the accumulator cell, or the supporting force applied by way of the counterholder 40, a crescent-shaped, or a substantially crescent-shaped, adhesive gap 32 is achieved. For this purpose, the contact face has a radius which is smaller, for example, than a radius of the accumulator cell 1. An adhesive gap of this type enables a very defined distribution of adhesive. Moreover, in particular thin and uniform adhesive gaps can be achieved. The adhesive gaps are thus not derived anyhow or randomly, but are in particular predefined by the shape of the counterholder 40, or the contact face 44 of the latter, respectively.

FIG. 5 schematically shows the procedure when arranging a plurality of segments 10 next to one another. The segments 10 presently have in each case one first cell row 11, i.e. are single-row segments. Presently illustrated are a multiplicity of accumulator cells 1 which extend along a vertical axis H and form the first cell rows 11. It is schematically illustrated that a (new) segment 10 is arranged from the right on segments 10 which are already arranged next to one another. The arrangement herein expediently takes place within the chemical cure time of the adhesive used, at least of the right segment 10. The arrangement of the right segment 10, from the right to the left, on the already existing arrangement here expediently takes place in such a manner that pressing takes place by way of the accumulator cells 1. Thus, the corresponding cooling element 20 is pressed onto the already existing segments 10, or the accumulator cells 1, by way of the accumulator cells 1 of the right segment 10. The cooling elements 20 are expediently connected to one another by way of corresponding connecting elements 24.

### List of Reference Signs

1 Accumulator cell
10 Segment
11 First cell row
20 Cooling element
21 First lateral face
22 Second lateral face
24 Connecting element
30 Adhesive
32 Adhesive gap
40 Counterholder
42 Compression piece
44 Contact face
50 Handling device
52 Pivoting device
L Longitudinal axis
H Vertical axis
D Compressive force
G Counter force
A Arrangement direction

1-15. (canceled)

16. A method for producing an electrical accumulator, the method comprising the steps of:
providing a cooling element which extends along a longitudinal axis and has a first lateral face and a second lateral face;
applying adhesive to the first lateral face;
arranging at least one accumulator cell on the first lateral face and, in doing so, supporting in a form-fitting manner the cooling element from a direction of the second lateral face.

17. The method according to claim 16, further comprising the step of:
using a counterholder for the supporting, which counterholder over an entire area or in portions is adapted to a target shape of the cooling element.

18. The method according to claim 16,
wherein the cooling element has a wave shape along the longitudinal axis; and
wherein accumulator cells are, in each case, positioned in respective wave troughs of the wave shape.

19. The method according to claim 16, further comprising the step of:
recalibrating or aligning the cooling element when arranging the at least one accumulator cell, or by way of the arrangement of the latter.

20. The method according to claim 16, further comprising the step of:
forming the cooling element when arranging the at least one accumulator cell such that an adhesive gap is formed at least in regions, which when viewed along a vertical axis is a shape of a crescent, or substantially in the shape of a crescent.

21. The method according to claim 16, further comprising the step of:
holding the at least one accumulator cell during the arranging such that an alignment relative to the cooling element occurs.

22. The method according to claim 16, further comprising the step of:
arranging a multiplicity of accumulator cells on the first lateral face sequentially or simultaneously, so as to generate a first cell row;
applying adhesive to the second lateral face of the cooling element.

23. The method according to claim 22, further comprising the step of:
arranging a multiplicity of accumulator cells on the second lateral face sequentially or simultaneously, so as to generate a second cell row.

24. The method according to claim 23, further comprising the step of:
arranging a multiplicity of segments next to one another, each segment comprising one cooling element and one or two cell rows, so as to generate or construct an accumulator.

25. The method according to claim 24, further comprising the step of:
arranging a segment prior to a chemical cure time of the adhesive used for the respective segment expiring; and
positioning the cooling element on another cell row prior to the chemical cure time of the adhesive used expiring.

26. An apparatus for producing an electrical accumulator, comprising:
at least one counterholder; and
a handling device;
wherein the counterholder is configured for arranging and supporting, at least in regions, a cooling element which extends along a longitudinal axis; and
wherein the handling device is configured for arranging at least one accumulator cell on the cooling element which is disposed on the counterholder.

27. The apparatus according to claim 26, wherein the counterholder is displaceable at least along a vertical axis.

28. The apparatus according to claim 26,
wherein the counterholder has a multiplicity of compression pieces which are configured to support the cooling element in regions and portions.

29. The apparatus according to claim 26, wherein
the counterholder is configured to support a cooling element over an entire area.

30. The apparatus according to claim 26, wherein
a contact face of the counterholder that is provided to support the cooling element in regions has a radius which is configured to generate a crescent-shaped adhesive gap between the cooling element and a respective accumulator cell.
